(19) United States
(12) Patent Application Publication
(10) Pub. No.: US 2010/0101530 A1
(43) Pub. Date: Apr. 29, 2010

(54) GASOLINE DIRECT INJECTION ENGINE

(75) Inventor: Bong Sang LEE, Suwon-city (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/564,727

(22) Filed: Sep. 22, 2009

(30) Foreign Application Priority Data
Oct. 28, 2008 (KR) 10-2008-0105843

(51) Int. Cl. F02B 5/00; F02M 61/14

(52) U.S. Cl. 123/305; 123/470

(57) ABSTRACT

A gasoline direct injection engine may include a combustion chamber, an intake port and an exhaust port, an intake valve and an exhaust valve that open and close the intake and exhaust ports, respectively, an injector injecting fuel into the combustion chamber through an injecting hole formed at an lateral portion of the combustion chamber, an injector mounting surface having a taper structure to receive the injector therein, a seal ring that is disposed between the injecting hole and the injector mounting surface and that fixes the injector such that the injector does not extrude from an inner wall of the combustion chamber by encompassing an exterior circumference of the injector, a slanted surface that is formed around an inner circumference of the injecting hole, and is slanted in an injecting direction of the injector with a predetermined angle, and an ignition plug igniting a mixture in the combustion chamber.

### CROSS-REFERENCE TO RELATED APPLICATION

The present application claims priority to Korean Patent Application No. 10-2008-0105843 filed on Oct. 28, 2008, the entire contents of which are incorporated herein for all purposes by this reference.

### BACKGROUND OF THE INVENTION

1. Field of the Invention

The present invention relates to a gasoline direct injection engine that directly injects fuel into a combustion chamber, and more particularly to an engine for minimizing interference generated between an injector and fuel.

2. Description of Related Art

Recently, gasoline direct injection (GDI) engines that directly inject fuel into a combustion chamber have been suggested and developed.

The GDI engine is formed in such a manner that air flows from an intake port to a combustion port so as to be compressed by a reciprocal motion of a piston in the case of opening of an intake port, and then the fuel is injected toward the compressed air at a high pressure.

The high-pressure air and the fuel are mixed in a sprayed state in the combustion chamber, the mixture reaches the ignition plug and is ignited for generating a driving torque, and resulting combusted fuel is exhausted to an exhaust port when an exhaust valve is opened.

Therefore, the GDI engines make it possible for a vehicle to burn an ultra-lean mixture owing to uniform injecting into the combustion chamber during a process of an intake stroke.

As a result of the foregoing, fuel mileage can be improved, and the CO₂ exhaust amount can be decreased.

The GDI engines inject fuel to the intake air in the combustion chamber while the air flows into the combustion chamber in the case of opening the intake valve during the air intake stroke.

At this time, the mixtures are distributed in a sprayed state substantially in the combustion chamber, and the mixture is ignited by the ignition plug such that the mixture is uniformly combusted.

In such a GDI engine, an injector is employed in order to inject the fuel with a high pressure into the combustion chamber.

At this time, since the fuel should be injected into the combustion chamber without any nearby interference, the injector is mounted at the interface of the combustion chamber according to the conventional layout.

And, an injection hole is formed at the end of the injector for injecting the fuel, and it is opened toward the interior of the combustion chamber.

Furthermore, fuel that is pressurized is required for injection into the combustion chamber without any nearby interference.

However, since the injection hole is inevitably exposed to the combustion chamber, carbon is accumulated around the injection hole, or performance is deteriorated due to interference and being exposed to high temperature combustion gas in operation of the engine.

As a result of the foregoing, fluid volume of fuel injected from the injector is reduced and a haze state is deteriorated.

Therefore, the shape of the injector formed at a boundary of the combustion chamber may affect the operating performance of the engine.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a gasoline direct injection engine having advantages of minimizing interference of high-pressure fuel injected from an injector so as to improve operability of the engine.

In an aspect of the present invention, the gasoline direct injection engine may include a combustion chamber, an intake port and an exhaust port communicating with the combustion chamber, an intake valve and an exhaust valve that open and close the intake and exhaust ports, respectively, an injector injecting fuel into the combustion chamber through an injecting hole formed at an lateral portion of the combustion chamber, an injector mounting surface having a taper structure in which a cross-section thereof becomes wider toward an upper portion thereof to receive the injector therein, a seal ring that is disposed between the injecting hole and the injector mounting surface and that fixes the injector such that the injector does not extrude from an inner wall of the combustion chamber by

encompassing an exterior circumference of the injector, a slanted surface that is formed around an inner circumference of the injecting hole, and is slanted in an injecting direction of the injector with a predetermined angle, and an ignition plug igniting a mixture in the combustion chamber.

The predetermined angle of the slanted surface may be in a range of approximately 5 degrees to approximately 30 degrees from a horizontal coordinate.

A cross-section of the slanted surface may be in a range of approximately 80% to approximately 220% in comparison with a cross-section of the injection hole of the injector.

Accordingly, the gasoline direct injection engine according to various aspects of the present invention can improve operability of the engine by reducing a pressure loss when high-pressure fuel is injected into the combustion chamber.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a cross-sectional view of a gasoline direct injection engine according to an exemplary embodiment of the present invention.

FIG. 2 is an enlarged view of an A region in FIG. 1

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

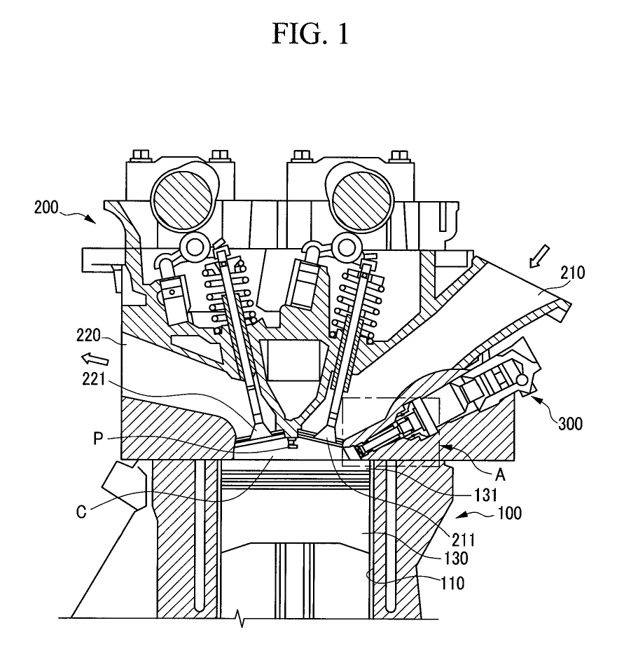

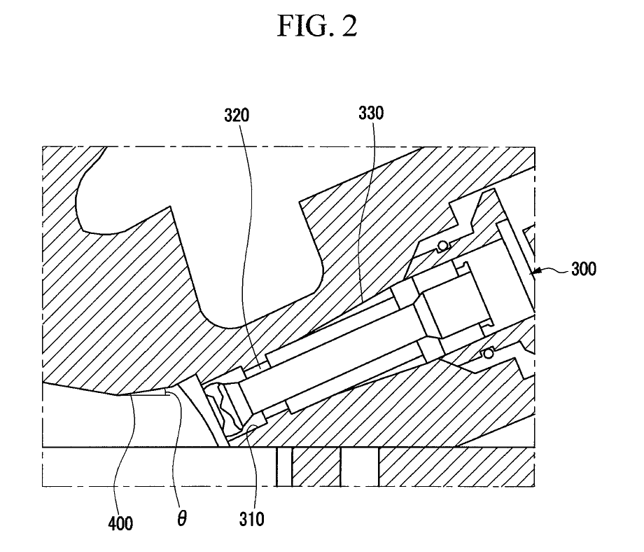

FIG. 1 is a cross-sectional view of a gasoline direct injection engine according to an exemplary embodiment of the present invention, and FIG. 2 is an enlarged view of an A region in FIG. 1.

As shown in FIG. 1 and FIG. 2, a gasoline direct injection engine according to an exemplary embodiment of the present invention includes a cylinder block 100 mounted at the lower portion of a cylinder head through a plurality of mounting bolt.

A plurality of cylinder bores (only one cylinder is shown in the drawings for convenience of description) are disposed at the cylinder block 100, and a piston 130 is slidably mounted at each of the cylinder bores 110.

In addition, a crankshaft is rotatably mounted at the lower portion of the cylinder block 100, and each piston 130 is connected to the crankshaft through a connecting rod.

The combustion chamber C includes the cylinder bore 110 defined at an inner wall of the cylinder block 100, a space defined by a piston head 131 and the lower surface of the cylinder head 200, and the roof portion, i.e., the lower end surface of the cylinder head is formed such that the center portion of the cylinder head is not high and has a slanted shape as a polygon.

An intake port 210 and an exhaust port 220 are formed at the lower surface of the cylinder head 200, i.e., an upper portion of the combustion chamber C, so as to face each other.

Furthermore, an intake valve 211 and an exhaust valve 221 are disposed at the lower end of the intake port 210 and the exhaust port 220.

The intake valve 211 and the exhaust valve 222 are each supported by a valve guide so as to reciprocally move, and are simultaneously elastically supported against the intake port 210 and the exhaust port 220 through valve springs.

Since the intake valve 211 and exhaust valve 221 may be employed in a conventional manner, the structures are not shown. However, an end of a roller rocker arm is connected to the upper end of the cylinder head, the other end of the roller rocker arm is connected to a lash adjuster fixed at the cylinder head 200, and cams of an exhaust camshaft are contacted to each roller rocker arm.

Therefore, when the intake cam shaft and the exhaust cam shaft are rotated in synchronization with the rotation of the engine, the intake/exhaust cam operates the roller rocker arm, and the intake valve and exhaust valve are reciprocally moved with predetermined timing such that the intake port 210 and exhaust port 220 can be opened or closed.

An injector 300 that directly injects fuel is mounted at the lower surface of the cylinder head 200, i.e., at a lateral portion of the combustion chamber C at a side of the intake port 210.

Further, an ignition plug P is mounted between the intake port 210 and the exhaust port 220, i.e., at the top of the center of the combustion chamber C on a lower surface of the cylinder head 200.

Further, an electronic control unit is provided so as to control fuel injection amount and injection timing of the injector 300 and ignition timing of the ignition plug P, and it determines fuel injection amount, injection timing, and ignition timing based on operation conditions of the engine such as intake air amount, engine speed, and throttle opening.

Additionally, the injector 300 is opened toward the combustion chamber C, and a slanted surface 400 that is wedge-shaped is formed at an upper wall of the combustion chamber C, namely, around the circumference of the injection hole 310 of the injector 300.

The slanted surface 400 is formed to bias a flow direction of the high-pressure fuel injected from the injector 300.

The angle θ of the slanted surface 400 may preferably be in a range of 5 to 30 degrees about a horizontal line.

Further, the cross-section of the slanted surface 400 may preferably be in a range of 80% to 220% in comparison with the cross-section of the injection hole 310 of the injector 300.

According to the shape of the slanted surface 400, high-pressure fuel can be injected by the injector 300 without interference from the circumference thereof, and at this time, the injection hole 310 must not protrude over the lateral boundary of the combustion chamber C.

At this time, a seal ring 320 encompassing an exterior circumference of a lower portion of the injector 300 is provided such that the injecting hole 310 does not extrude from the boundary of the inner wall of the combustion chamber C.

The seal ring 320 may preferably be made of a rubber material, and it is mounted at a lower end of the injector mounting surface 330 with the injector 300 mounted therein.

That is, when the injector 300 is inserted into the injector mounting surface 330, the combustion chamber C is sealed by the seal ring 320, and the injector 300 is fixedly supported by the seal ring 320.

In this case, the injector mounting surface 330 may be a normal taper structure in which cross-sectional areas thereof become wider toward upper parts thereof, and a step formed at an upper end thereof may be provided so as to fix the injector 300.

Therefore, operability of the engine can be improved by minimizing interference from the circumference thereof when high-pressure fuel is injected through the injection hole 310 of the injector 300.

For convenience in explanation and accurate definition in the appended claims, the terms “upper”, “lower”, and “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A gasoline direct injection engine comprising:
a combustion chamber;
an intake port and an exhaust port communicating with the combustion chamber;
an intake valve and an exhaust valve that open and close the intake and exhaust ports, respectively;
an injector injecting fuel into the combustion chamber through an injecting hole formed at an lateral portion of the combustion chamber;
an injector mounting surface having a taper structure in which a cross-section thereof becomes wider toward an upper portion thereof to receive the injector therein;
a seal ring that is disposed between the injecting hole and the injector mounting surface and that fixes the injector such that the injector does not extrude from an inner wall of the combustion chamber by encompassing an exterior circumference of the injector;
a slanted surface that is formed around an inner circumference of the injecting hole, and is slanted in an injecting direction of the injector with a predetermined angle; and
an ignition plug igniting a mixture in the combustion chamber.

2. The gasoline direct injection engine of claim 1, wherein the predetermined angle of the slanted surface is in a range of approximately 5 degrees to approximately 30 degrees from a horizontal coordinate.

3. The gasoline direct injection engine of claim 1, wherein a cross-section of the slanted surface is in a range of approximately 80% to approximately 220% in comparison with a cross-section of the injection hole of the injector.
